(19) United States
(12) Patent Application Publication
(10) Pub. No.: US 2005/0089615 A1
(43) Pub. Date: Apr. 28, 2005

(54) Method for sterilising food products, by injected steam, in particular purees and/or concentrates

(76) Inventors: Pierluigi Arelli, Parma (IT); Roberto Lusardi, Parma (IT); Gerardo Paciello, Pignola (IT)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/501,337

(22) PCT Filed: Oct. 29, 2002
(86) PCT No.: PCT/IT02/00690

(30) Foreign Application Priority Data
Jan. 24, 2002 (IT) PR2002 A 000001

(51) Int. Cl. A23L 3/16

(52) U.S. Cl. 426/521

(57) ABSTRACT

Method for sterilising food products, in particular purees and/or concentrates, of the type comprising at least a step of heating the product by injection of steam at predetermined temperature and at least a step of mixing the product to allow a substantially uniform distribution of the steam. Said mixing step originally takes place by means of at least a dynamic mixer. A possible dynamic mixer able to implement said mixing step comprises at least a tank for collecting the product, at least an agitator associated with the tank and operatively active on the product to mix it and means for actuating the agitator.

### TECHNICAL FIELD AND BACKGROUND ART

The present invention relates to a method for sterilising food products, in particular purees and/or concentrates, of the type comprising a step of heating the product by injecting steam at predetermined steam and a step of mixing the product, to allow a uniform distribution of the steam and consequently a heating that is as homogeneous as possible.

Currently, such a type of method is particularly adopted in the food sector of the manufacture of juices and/or concentrates of fruit and/or vegetables, such as tomatoes.

A first known method provides for the heating to take place by means of a pair of coaxial conduits. In particular, the smaller-diameter conduit, within which flows the product to be heated, is externally lapped by a heating fluid that flows in the larger-diameter conduit.

A heating operated according to said procedures has the drawback of heating effectively only the mass of product that is in direct contact with the walls of the inner conduit that are lapped by the heating fluid. Therefore, the mass of product that is substantially in correspondence with the centreline of the inner conduit undergoes an insufficient heating to assure the sterility of the product. In accordance with a second known method, the product is heated by injecting hot steam into it. While this method does allow for better heating than the first method, it nonetheless has the drawback of not assuring temperature stability within the product.

In particular, areas of products with insufficient temperature may be created, thereby compromising the asepsis of the final product. It is not possible to obtain a uniform distribution of the steam inside the product due to the different physical state of the steam and of the product itself, normally respectively gaseous and liquid.

To overcome this drawback, the product is heated to a higher temperature than the one actually required to guarantee sterilisation, so that, even in the presence of temperature variations, the temperature of the product never drops below a minimum value that guarantees its asepsis. However, overheating entails the additional problem of deteriorating the quality of the product, changing its chemical-physical characteristics, such as taste, viscosity and/or consistency.

According to a third known method, the product is made to advance inside a conduit having, on its outer lateral walls, a plurality of recesses whereto correspond an equal number of projections on the inner lateral walls, which thus are undulated. During its advance inside the conduit, the product is heated by injection of hot steam and, by effect of the turbulence generated by the undulation of the inner walls of the conduit, the product undergoes a mixing that should favour a uniform distribution of the steam and consequently a homogeneous heating.

The method described above has the important drawback of being sensitive to the mass flow rate of the product. In particular, a different mass flow rate from the one for which the conduit was dimensioned influences the turbulence generated by the inner walls of the conduit and therefore does not allow a uniform distribution of the steam, favouring temperature variations.

An additional drawback, therefore, is represented by the impossibility of throttling the plant, without compromising the asepsis of the product at the end of the treatment.

### DISCLOSURE OF INVENTION

An aim of the present invention is to eliminate the aforesaid drawbacks making available a method for sterilising food products, in particular purees and/or concentrates, which allows uniformly to heat the product to be treated, without any deterioration of its quality.

An additional aim of the present invention is to propose a sterilising method that allows to throttle the plant, without compromising the asepsis of the f& product.

Another aim of the present invention is make available a method that allows a chemical-physical homogenisaton of the product, drastically reducing its degradation.

A further aim of the present invention is to propose a sterilisation method that is simple and economical to implement.

Said aims are fully achieved by the method for sterilising food products, in particular purees and/or concentrates, of the present invention, which is characterised by the content of the claims set out below and in particular in that the method provides for executing the mixing step by means of at least a dynamic mixer.

### BRIEF DESCRIPTION OF DRAWINGS

This and other characteristics shall become more readily apparent from the following description of a preferred embodiment of the method illustrated, purely by way of non limiting example, in the accompanying drawing tables, in which:

FIG. 1 shows a portion of an embodiment of a plant for sterilising food product that implements a method according to the invention;

FIG. 2 shows a partially sectioned lateral view of a first constructive detail of the plant of FIG. 1;

FIG. 3 shows a partially sectioned axonometric view of a second constructive detail of the plant of FIG. 1.

### BEST MODE FOR CARRYING OUT THE INVENTION

The method of the invention is of the type comprising at least a step of heating the product by injecting steam at predetermined temperature; in particular, the steam must be sufficiently hot to guarantee the asepsis of the product at the end of the treatment.

The method comprises at least a step of mixing the product, in order to enable a uniform distribution of the steam and consequently an equal heating of the product itself.

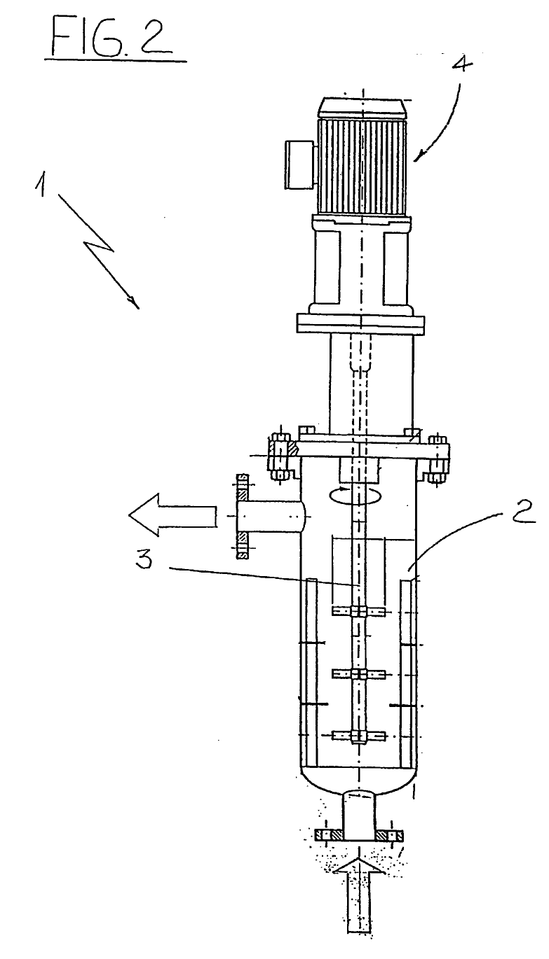

Said mixing step originally takes place by means of at least a dynamic mixer. FIG. 2 shows, purely by way of example, a possible embodiment of a dynamic mixer able to carry out the aforesaid mixing step in accordance with the method.

With reference to FIG. 2, the dynamic mixer is globally indicated with the number 1 and comprises a tank 2 for collecting the product, typically food puree or concentrate, an agitator 3 inserted in the tank to mix the product to be sterilised and means 4 for actuating the agitator. In particular, said means preferably comprise an electric motor.

The method also comprises a step of mixing the product by means of at least a static mixer.

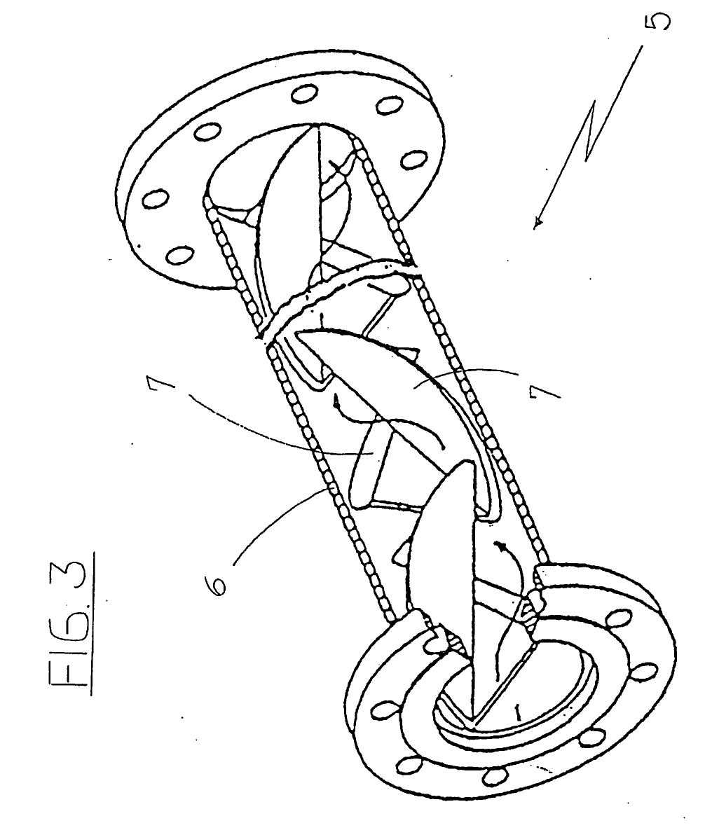

FIG. 3 shows, purely by way of example, a possible embodiment of a static mixer able to carry out the aforesaid mixing step in accordance with the method.

With reference to FIG. 3, the static mixer is globally indicated with the number 5 and comprises a tubular body 6 inside which flows the products typically food puree or concentrate, a plurality of fixed baffles 7, positioned inside the tubular body and so shaped as to operate continuous deviations of the product and separation of the threads, to allow its mixing by effect of the turbulence that develops.

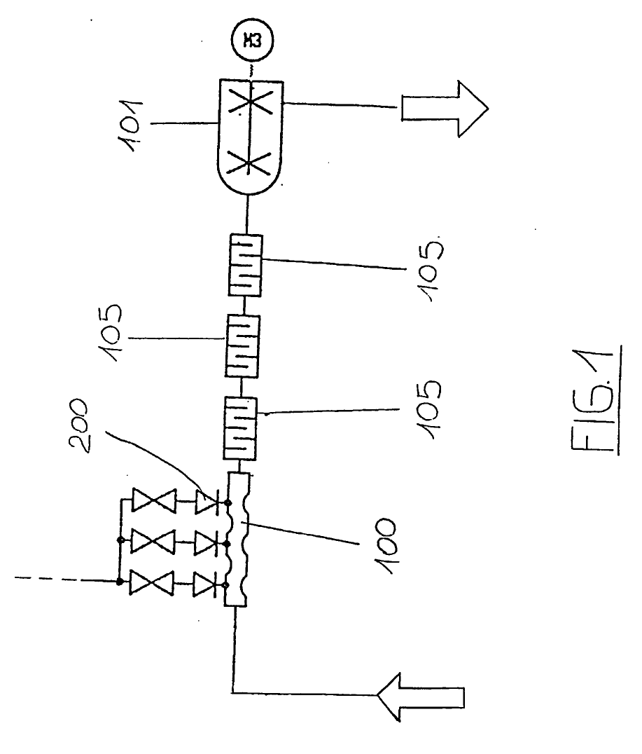

FIG. 1 shows a possible embodiment of the method according to the invention.

The product flows inside a conduit 100, which has undulated inner walls in accordance with the prior art and is provided with a plurality of steam injectors 200.

Subsequently, the heated product flows inside one or more static mixers 105, which perform a first coarse mixing to uniform the temperature of the product.

Thereafter, the pre-mixed product reaches a dynamic mixer 101 which performs a fine mixing, uniforming the temperature of the product and assuring its sterilisation.

According to an embodiment variation, the heating and mixing steps can be simultaneous. In this case, the steam injection takes place by means of a plurality of nozzles preferably associated directly to the dynamic mixer, thereby obtaining a single processing stage.

The method of the invention achieves important advantages.

First of all, such a method allows to heat the product in uniform fashion, assuring temperature stability and guaranteeing asepsis. In particular, the use of a dynamic mixer allows a chemical-physical homogenisation of the product, drastically reducing its degradation and safeguarding the organoleptic characteristics such as taste and colour, or the physical characteristics, such as viscosity and consistency.

Secondly, a mixing step carried out by means of dynamic mixers allows to throttle the plant, without compromising a uniform temperature distribution inside the product and thus guaranteeing the asepsis of the final product.

Advantageously, said method is simple and economical to implement and can be used to sterilise even products with high viscosity.

Another advantage is represented by the fact that, given the presence of dynamic mixers, the static mixers and the undulated conduits into which the steam is injected can have reduced length, since the turbulence created by them in the product is not the sole source of mixing action. Thank to conduits of reduced length, therefore, it is possible to reduce head losses inside the plant, achieving considerable energy savings and lower pressures of the injected steam. This is even more readily apparent if the heating step is simultaneous with the mixing step and both take place inside a dynamic mixer, in accordance with the described embodiment variation.

1. Method for sterilising food products, in particular purees and/or concentrates, comprising the distinct and subsequent steps of:
heating the product by injection of steam at predetermined temperature to ensure the asepsis of the product;
mixing the product through at least a static mixer (105) to allow a substantially uniform distribution of the steam;
characterised in that the mixing step takes place by means of at least a dynamic mixer,
mixing the product in a dynamic mixer (101) which performs a fine mixing, the static and dynamic mixing performing an equal heating of the product uniforming the temperature of the product and ensuring its sterilisation.

2. Method as claimed in claim 1, characterised in that the disc mixer comprises:
at least a tank for collecting the product;
at least an agitator associated with the tank and operatively active on the product to mix it;
means for actuating the agitator.

3. Method as claimed in claim 1, characterised in that it further comprises a step of mixing the product by means of at least a static mixer.

4. Method as claimed in claim 1, characterised in that the static mixer comprises:
at least a tubular body within which the product flows;
a plurality of fixed baffles, positioned inside the tubular body and so shaped as to operate continuous deviations of the product, to allow its mixing.

5. Method as claimed in claim 1, characterised in that the heating and mixing steps are simultaneous.

6. Method as claimed in claim 5, characterised in that the steam injection takes place by means of a plurality of nozzles directly associated with the dynamic mixer.
